(19) United States
(12) Patent Application Publication
(10) Pub. No.: US 2006/0037043 A1
(43) Pub. Date: Feb. 16, 2006

(54) Method and interface for managing movies on a set-top box

(75) Inventors: Philip Ted Kortum, Austin, TX (US); Marc Andrew Sullivan, Austin, TX (US); James L. Cansler JR., Pflugerville, TX (US); Alyssa Lenorah Noll Williams, Elmhurst, IL (US)

Correspondence Address: TOLER & LARSON & ABEL L.L.P., 5000 PLAZA ON THE LAKE STE 265, AUSTIN, TX, 78746, US

(73) Assignee: SBC Knowledge Ventures, L.P.

(21) Appl. No.: 10/915,684

(22) Filed: Aug. 10, 2004

(51) Int. Cl. H04N 5/445; G06F 13/00; G06F 3/00

(52) U.S. Cl. 725/37; 725/39; 725/61

(57) ABSTRACT

A method of managing video content is provided. The method includes displaying a graphical user interface. The graphical user interface comprising a ready list, a queue list, and an action list. When a first video file is downloaded to a memory within a set top box, a first title corresponding to the first video file is added to the ready list. Further, when the first title is selected from the ready list, the first video file is displayed. Additionally, a second video file can be scheduled for download to the memory within the set top box and if so, a second title corresponding to the second video file is added to the queue list. When the second title is selected from the queue list, the second video file is downloaded to the memory within the set top box.

### FIELD OF THE INVENTION

The present disclosure relates to set top box interfaces.

### BACKGROUND

For years, televisions have been a staple of consumer electronics sales. As such, a large majority of households in the United States owns at least one television. Providing content to those televisions is a lucrative business and there are numerous types of television content to choose from. For example, viewers can subscribe to digital broadband television networks and digital satellite television networks in order to receive standard digital television content or high definition television content via a broadband connection or a satellite connection. In addition, many companies now offer digital video recorders (DVRs) that can be incorporated into standard set top boxes. A DVR can be used to record digital television content transmitted to the set top box.

Further, there are some companies that offer video on-demand, which can allow a user to simply choose a program of interest from a list of available programs and schedule it for immediate viewing. Movies can also be viewed in this manner. In other words, a user can change the channel of a set top box to a video on-demand pay-per-view movie channel, toggle a button via a remote, and begin viewing the movie immediately. Current user interfaces for such video on-demand systems have limited functionality.

Accordingly, there is a need for an improved method and graphical user interface for managing movies on a set-top box.

### BRIEF DESCRIPTION OF THE DRAWINGS

The present invention is pointed out with particularity in the appended claims. However, other features are described in the following detailed description in conjunction with the accompanying drawings in which:

FIG. 1 is a block diagram representative of an entertainment system;

FIG. 2 is a general diagram representative of a graphical user interface that can be used to access movies to be broadcast via the entertainment system;

FIG. 3 is a flow chart to illustrate general operating logic that can be used to access movies and broadcast them via the entertainment system;

FIG. 4 is a general diagram illustrating a first warning screen of the graphical user interface; and

FIG. 5 is a general diagram illustrating a second warning screen of the graphical user interface.

### DETAILED DESCRIPTION OF THE DRAWINGS

A method of managing video content is provided. The method includes displaying a graphical user interface. The graphical user interface comprising a ready list, a queue list, and an action list. When a first video file is downloaded to a memory within a set top box, a first title corresponding to the first video file is added to the ready list. Further, when the first title is selected from the ready list, the first video file can be displayed.

Additionally, a second video file can be scheduled for download to the memory within the set top box. If so, a second title corresponding to the second video file is added to the queue list. When the second title is selected from the queue list, the second video file can be downloaded to the memory within the set top box. In an illustrative embodiment, if a number of titles in the ready list reaches a predetermined limit, a user can be prompted by a warning screen to delete the first video file from the memory before the second video file is downloaded to the memory.

Further, if a third title that corresponds to a third video file is selected, the third title can be added to the queue list to be downloaded at a later time. Alternatively, when a third title is selected, the third title can be added to ready list and a third video file can be downloaded to the memory within the set top box.

In another embodiment, a device for managing video content is provided and includes a processor that has a computer readable medium. A computer program is embedded within the computer readable medium and includes instructions for displaying a graphical user interface at a display device. The graphical user interface includes a ready list, a queue list, and an action list. Additionally, the computer program includes instructions for downloading a first video file to a memory and instructions for adding a first title corresponding to the first video file to the ready list.

In yet another embodiment, a method of managing video content is provided and includes displaying a ready list at a display device. The ready list comprises a list of titles corresponding to video files that are downloaded to a memory within a set top box. Also, a queue list can be displayed at the display device and includes a second list of titles corresponding to video files that are to be downloaded to the memory. Further, an action list can be displayed at the display device. The action list can include a play key, a summary key, a move up key, a move down key, and a delete key.

In still another embodiment, a system for managing video content includes a display device and a set top box that is coupled to the display device. The set top box includes a processor that is coupled to a computer readable memory. The memory includes a ready list that has a list of titles that correspond to video files that are downloaded to a memory within a set top box and suitable for display at the display device. Also, the memory includes a queue list that has a second list of titles that correspond to video files that are targeted to be downloaded to the memory within the set top box.

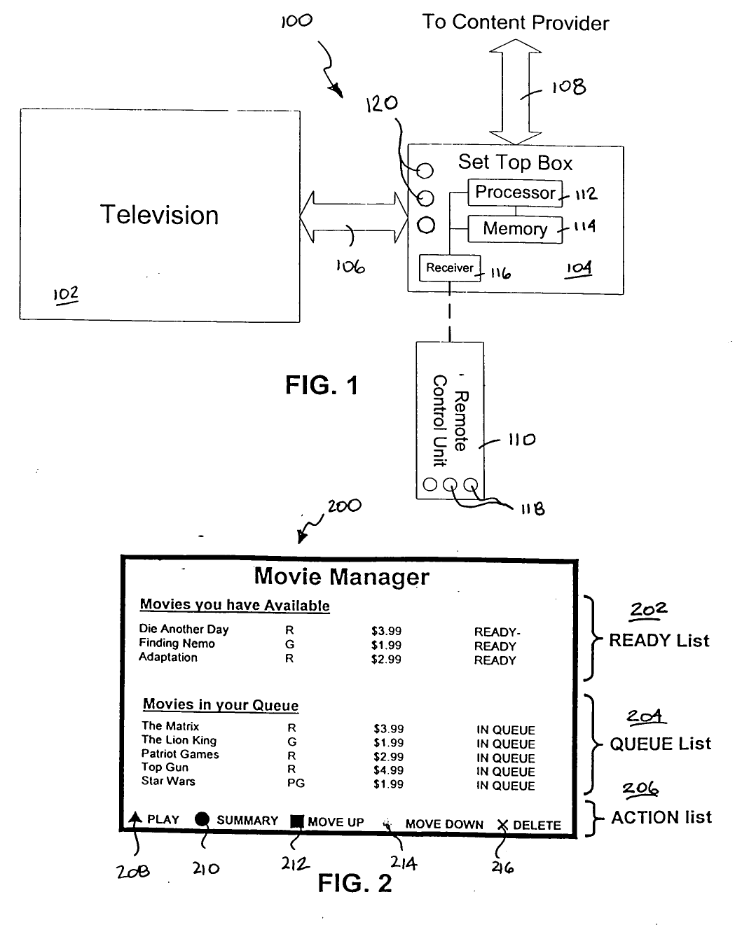

Referring to FIG. 1, a system for managing movies provided at a television is illustrated and is generally designated 100. As illustrated in FIG. 1, in an exemplary, non-limiting embodiment, the system 100 includes a television 102, but it can be appreciated that the system 100 can include any display device on which video content can be displayed. FIG. 1 indicates that a set top box 104 can be connected to the television 102 via a first broadband connection 106. The set top box 104 is also connected to a video content provider, e.g., a cable company or a digital satellite company, via a second broadband connection 108. FIG. 1 also depicts a remote control unit 110 that can communicate with the set top box 104 to allow user interaction with the system 100 during operation—as described below. The remote control unit 110 can communicate with the set top box 104 via one or more infrared (IR) signals, radio frequency (RF) signals, or other wireless signals.

As indicated in FIG. 1, the set top box 104 includes a processor 112 in which logic, such as user interface logic, can be executed. Further, the set top box 104 includes a memory 114 in which content from the content provider can be downloaded and stored. FIG. 1 also shows that the set top box 104 can include a receiver 116, e.g., an IR/RF receiver, that is configured to receive one or more IR/RF signals from the remote control unit 110. Moreover, as depicted in FIG. 1, the remote control unit 110 can include a plurality of buttons 118 that can be toggled by a user during operation, e.g., in order to cause one or more video files to be downloaded from the content provider. As shown in FIG. 1, the set top box 104 can also include a plurality of buttons 120 that can be toggled by a user during operation.

FIG. 2 depicts an exemplary, non-limiting embodiment of a graphical user interface (GUI), generally designated 200, that can be presented to a user at the television 102 (FIG. 1) during operation of the system 100. In one embodiment, the GUI 200 can include a ready list 202, a queue list 204, and an action list 206. The ready list 202 can contain a list of movie titles that correspond to video files that have been downloaded to the set top box 104 (FIG. 1), e.g., to the memory 114 (FIG. 1), and that are available to be viewed at the television 102 (FIG. 1). Moreover, the ready list 202 can include a brief description of each movie title. For example, the ready list 202 can include information concerning the rating of the movie, e.g., G, PG, R, NR, etc., the price to view the movie, and whether the movie is currently ready for viewing.

It can be appreciated that the video files corresponding to the movie titles presented by the ready list may or may not be completely downloaded to the memory 114 (FIG. 1) within the set top box 104 (FIG. 1) if streaming video is supported. If streaming video is supported by the system 100 (FIG. 1), the presence of a title in the ready list 202 may indicate that a sufficient portion of the corresponding video file has been downloaded into a buffer portion of the memory for video streaming to commence. The presence of a particular movie title can also indicate that the corresponding video file has been downloaded in its entirety to the memory 114 (FIG. 1) of the set top box 104 (FIG. 1). In an illustrative embodiment, the GUI 200 can include icons or text to indicate to a user whether a particular video file is going to be streamed or fully downloaded.

Further, in a particular embodiment, the queue list 204 can contain a list of movie titles that correspond to video files that a user wishes to see at some later date or time. The queue list 202 can also include information regarding the movie titles presented therein, e.g., ratings, prices, and download status. In an exemplary, non-limiting embodiment, the top item on the queue list 204 can be downloaded and moved to the ready list 202 when space in the ready list 202 becomes available, e.g., after a movie title has been deleted from the ready list 202 and the corresponding video file has been deleted from the memory 114 (FIG. 1). It can be appreciated that in addition to showing the movies that are to be downloaded, the queue list 204 can also serve as a wish list for a user. In other words, a user can add a number of other movie titles to the queue list 204 in order to help keep track of the movies that the user may want to view at a later time.

As illustrated in FIG. 2 and in an exemplary, non-limiting embodiment, the action list 206 can include a plurality of action keys that a user can use to accomplish certain tasks using the remote control unit 110 (FIG. 1), e.g., by toggling the buttons 118 (FIG. 1) included in the remote control unit 110 (FIG. 1). FIG. 2 shows that the action list 206 can include a play key 208, a summary key 210, a move up key 212, a move down key 214, and a delete key 216. When the play key 208 is selected, a video file can be broadcast to the television 102 (FIG. 1), e.g., from the memory 114 (FIG. 1) in the set top box 104 (FIG. 1). The summary key 210 can be selected in order to present summary information to a user, e.g., summary information about video files downloaded or video files scheduled to be downloaded. In another embodiment, these tasks can be accomplished using one or more of the buttons 120 located at the set top box 104 (FIG. 1).

In an embodiment, the move up key 212 and the move down key 214 can be toggled, or otherwise selected, in order to navigate through the GUI 200, e.g., to select a movie title for viewing or downloading. In another embodiment, a user can highlight a movie title in the queue list 204 and then, use the move up key 212 or the move down key 214 in order to change the position of the highlighted movie title in the queue list 204. Further, the delete key 216 can be selected, e.g., to delete a movie title from the ready list 202 or the queue list 204. It can be appreciated that the action list 206 can include other keys for added functions other than those shown. For example, the action list 206 can include a browse key, a rent key, a set password key, an information key, and an exit key.

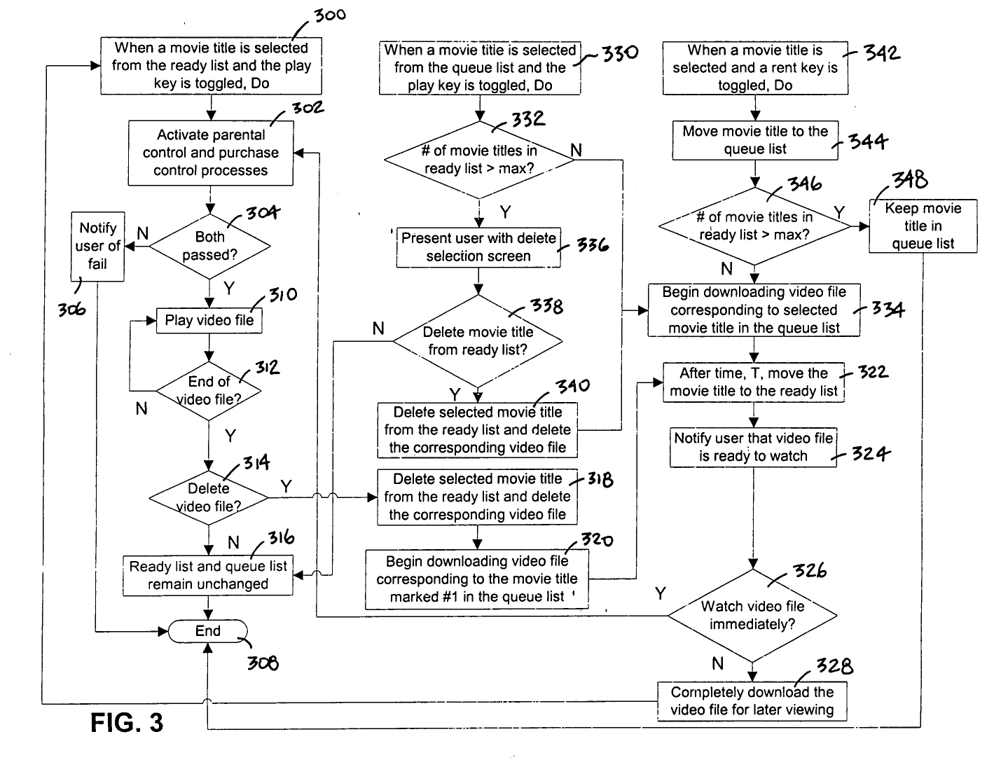

Referring to FIG. 3, a particular embodiment of operating logic of the system 100 (FIG. 1) is shown. The operating logic comprises three separate loops with several overlapping steps. Each loop is entered when certain actions are performed by the user via the GUI 200 (FIG. 2). Due to the overlap of some of the actions included in each loop, the logic will be described serially. However, after reading this specification, skilled artisans will appreciate that the loops can be entered in any particular order and the specific order of the steps described below may vary.

Commencing at block 300, when a movie title is selected from the ready list 202 (FIG. 2) and the play key is toggled, the following steps are performed. At block 302, the parental control and purchase control processes are activated. In an illustrative embodiment, these processes can require a user to input a password for each process, e.g., a parental control password and a purchase control password. Moving to decision step 304, an action is undertaken in order to determine whether both processes have passed, e.g., has the correct password been input for both processes. If either process fails, the logic proceeds to block 306 and the user is notified of the failure. The logic then ends at state 308. Returning to decision step 304, if both processes pass, e.g., a correct password has been input for both, the logic continues to block 310 and the video file corresponding to the selected movie title is played at the television 102 (FIG. 1).

Moving to decision step 312, an action is performed to determine whether the end of the video file is reached. If the end of the video file is not reached, the logic returns to block 310 and the video file continues to play. On the other hand, when the end of the video file is reached, the logic moves to decision step 314. At decision step 314, an action is undertaken in order to determine whether the user wants to delete the video file. This action can include presenting a question to the user via the GUI 200 (FIG. 2) concerning deleting the movie. If the user does not want to delete the video file, the logic proceeds to block 316 and the ready list 202 (FIG. 2) and the queue list 204 (FIG. 2) remain unchanged. However, if the user wants to delete the video file, the logic moves to block 318 and the selected video file is deleted from the ready list 202 (FIG. 2).

Continuing to block 320, the video file corresponding to the movie title identified as number one (1) in the queue list 204 (FIG. 2) begins downloading. At block 322, after a predetermined time, T, or after detection of a particular event such as a completed download, the movie title is moved to the ready list 202 (FIG. 2). Proceeding to block 324, the user is notified that the video file is ready to watch. Next, a decision is undertaken at step 326 in order to determine whether the user wants to watch the video file immediately. This decision can be made by presenting a question to the user and receiving a user response via the GUI 200 (FIG. 2). If the user wants to watch the video file immediately, the logic returns to block 302 and continues as described above. However, if the user wants to wait until a later time to watch the video file the logic moves to block 328 and the video file is completely downloaded to the memory 114 within the set top box 104 for later viewing. The logic then proceeds to block 300 and continues as described above.

Referring now to block 330, when a movie title is selected from the queue list 204 (FIG. 2) and the play key is selected, the succeeding steps are performed. At decision step 332, an action is undertaken in order to determine whether the number of movie titles in the ready list 202 (FIG. 2) is greater than a predetermined maximum, e.g., three movie titles. If the number of movie titles is less than the predetermine maximum, the logic continues to block 334 and the video file corresponding to the selected movie title in the queue list 204 (FIG. 2) begins downloading. The logic then moves to block 334 and continues as described above.

Returning to decision step 332, if the number of movie titles in the ready list 202 (FIG. 2) is greater than the predetermined maximum, the logic moves to block 336 where the user is presented with a delete selection screen, e.g., one of the delete selection screens described in detail below. Thereafter, an action is undertaken at decision step 338 in order to determine whether the user wants to delete a particular movie title from the ready list 202 (FIG. 2). If not, the logic proceeds to block 316 and continues as described above. Conversely, if the user does want to delete a particular movie title from the ready list 202 (FIG. 2), the logic moves to block 340 and the selected movie title is deleted from the ready list 202 (FIG. 2) and the corresponding video file is deleted from the memory 114 (FIG. 1). The logic then moves to block 334 and continues as described above.

Moving to block 342, when a movie title is selected and a rent button is selected, the succeeding steps are performed. At block 344, the selected movie title is moved to the queue list 204 (FIG. 2). Thereafter, a decision is performed at step 346 in order to determine whether the number of movie titles in the ready list 202 (FIG. 2) exceeds a predetermined maximum. If not, the logic proceeds to block 334 and continues as described above. On the other hand, if the number of movie titles in the ready list does exceed the predetermined maximum, the logic continues to block 348 where the movie title is kept in the queue list. The logic then ends at state 308.

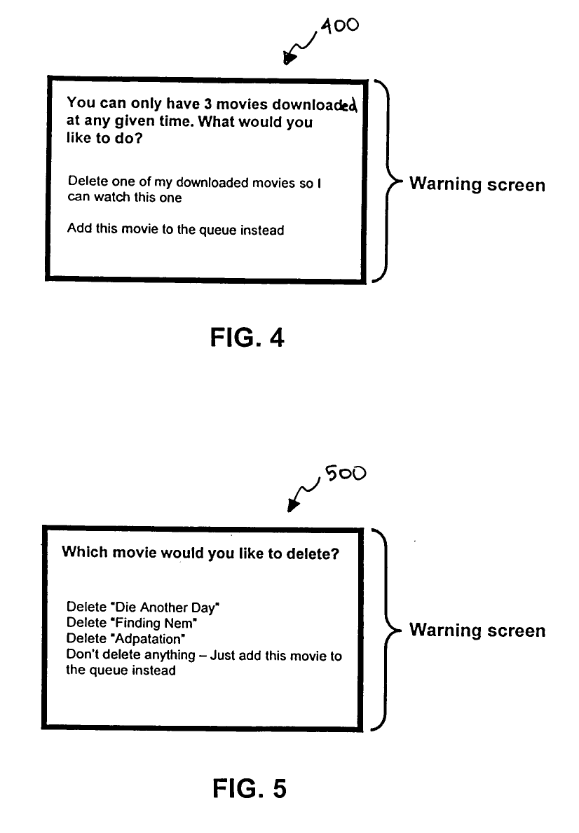

FIG. 4 depicts an exemplary, non-limiting embodiment of a warning screen, designated 400, that can be presented to a user via the GUI 200 (FIG. 2), described above. In a particular embodiment, the warning screen 400 can be presented via the GUI 200, if a user needs to be warned, such as a warning as to the limitation of the number of video files that can be simultaneously stored at the set-top box 104 (FIG. 1). For example, the warning screen 400 can present to the user an admonishment such as “You can only have 3 movies downloaded at any given time. What would you like to do?” Further, the warning screen 400 can present to the user one or more options such as “Delete one of my downloaded movies so I can watch this one” and “Add this movie to the queue instead.” Thus, a user is immediately and accurately warned that the memory 114 (FIG. 1) is full and space must be made for a new video file download to occur. In an embodiment, the user can select one of the choices presented by the warning screen 400 by using the remote control unit 110, e.g., by pressing one or more of the buttons 118 thereon, or by pressing one of the buttons 120 at the set top box 104.

FIG. 5 illustrates another exemplary, non-limiting embodiment of a warning screen, generally designated 500, that can be presented to a user via the GUI 200 (FIG. 2) in order to determine a movie title to delete from the ready list 202 (FIG. 2). For example, the warning screen 500 can present a question to the user such as, “Which movie would you like to delete?” Also, the warning screen 500 can present several delete options, e.g., “Delete [Movie # 1]′”, “Delete [Movie #2]′”, and “Delete [Movie #3]′”. Further, the warning screen 500 can present the user with a contingency option if the user does not want to delete any movie titles from the ready list 202 (FIG. 2). For example, the warning screen 500 can present an option such as, “Don't delete anything—Just add this movie to the queue instead.” Thus, if the user chooses this option the ready list 202 (FIG. 2) remains unchanged and a new title is added to the queue list 204 (FIG. 2). It can be appreciated that the user can select one of the choices presented by the warning screen 500 by pressing one of the buttons 118 on the remote control unit 110 or by pressing one of the buttons 120 at the set top box 104.

With the configuration of structure described above, the method and graphical user interface can provide a user-friendly and intuitive means for managing and viewing movies via a set-top box. Moreover, the method and graphical user interface can provide added functionality with respect to the management of those movies.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of managing video content, the method comprising:
displaying a graphical user interface at a display device, the graphical user interface comprising a ready list, a queue list, and an action list;
downloading a first video file to a memory within a set top box connected to the display device; and
adding a first title corresponding to the first video file to the ready list.

2. The method of claim 1, further comprising:
receiving a selection of the first title corresponding to the first video file from the ready list; and
displaying the first video file corresponding to the first title selected from the ready list.

3. The method of claim 2, further comprising:
scheduling a second video file to be downloaded to the memory; and
adding a second title corresponding to the second video file to the queue list.

4. The method of claim 3, further comprising:
receiving a selection of the second title from the queue list; and
downloading the second video file to the memory.

5. The method of claim 4, further comprising:
indicating that a number of titles in the ready list has reached a predetermined limit; and
displaying a warning screen at the display device to prompt a user to delete the first video file from the memory before the second video file is downloaded to the memory.

6. The method of claim 5, further comprising:
deleting the first video file from the memory; and
downloading the second video file to the memory.

7. The method of claim 6, further comprising:
receiving a selection of a third title corresponding to a third video file; and
adding the third title corresponding to the third video file to the queue list to be downloaded at a later time.

8. The method of claim 6, further comprising:
receiving a selection of a third title corresponding to a third video file;
adding the third title corresponding to the third video file in the ready list; and
downloading the third video file to the memory.

9. A device for managing video content, the device comprising:
a processor, the processor comprising a computer readable medium and a computer program embedded within the computer readable medium, the computer program comprising:
instructions for displaying a graphical user interface at a display device, the graphical user interface comprising a ready list, a queue list, and an action list;
instructions for downloading a first video file to a memory within the device for managing video content; and
instructions for adding a first title corresponding to the first video file to the ready list.

10. The device of claim 9, wherein the computer program further comprises:
instructions for receiving a selection of the first title corresponding to the first video file from the ready list; and
instructions for displaying the first video file corresponding to the first title selected from the ready list.

11. The device of claim 10, wherein the computer program further comprises:
instructions for scheduling a second video file to be downloaded to the memory; and
instructions for adding a second title corresponding to the second video file to the queue list.

12. The device of claim 11, wherein the computer program further comprises:
instructions for receiving a selection of the second title from the queue list; and
instructions for downloading the second video file to the memory.

13. The device of claim 12, wherein the computer program further comprises:
instructions for indicating that a number of titles in the ready list has reached a predetermined limit; and
instructions for prompting a user to delete the first video file from the memory before the second video file is downloaded to the memory.

14. The device of claim 13, wherein the computer program further comprises:
instructions for deleting the first video file from the memory; and
instructions for downloading the second video file to the memory.

15. The device of claim 13, wherein the computer program further comprises:
instructions for receiving a selection of a third title corresponding to a third video file; and
instructions for adding the third title corresponding to the third video file to the queue list to be downloaded at a later time.

16. The device of claim 13, wherein the computer program further comprises:
instructions for receiving a selection of a third title corresponding to a third video file;
instructions for adding the third title corresponding to the third video file in the ready list; and
instructions for downloading the third video file to the memory.

17. A method of managing video content, the method comprising:
displaying a ready list at a display device, the ready list comprising a list of titles corresponding to video files that are downloaded to a memory within a set top box;
displaying a queue list at the display device, the queue list comprising a second list of titles corresponding to video files that are to be downloaded to the memory; and
displaying an action list at the display device, the action list comprising a play key, a summary key, a move up key, a move down key, and a delete key.

18. The method of claim 17, further comprising:
detecting the selection of a movie title from the ready list;
detecting the selection of the play key;
activating a parental control process; and
activating a purchase control process.

19. The method of claim 18, further comprising:
receiving a parental control password;
receiving a purchase control password; and
verifying the parental control password and the purchase control password.

20. The method of claim 19, further comprising:
downloading a video file corresponding to the movie title; and
displaying the video file corresponding to the movie title.

21. The method of claim 20, further comprising:
detecting when the video file has ended;
deleting the video file from the memory; and
deleting the movie title corresponding to the video file from the ready list.

22. The method of claim 17, further comprising:
detecting the selection of a movie title from the queue list;
detecting the selection of the play key; and
displaying a delete selection screen when the number of movie titles in the ready list is greater than a predetermined limit.

23. The method of claim 22, further comprising:
downloading a video file corresponding to the movie title selected from the queue list;
moving the movie title from the queue list to the ready list after a predetermined time; and
indicating that the video file is ready for display.

24. A system for managing video content, the system comprising:
a display device;
a set top box coupled to the display device, the set top box comprising:
a processor, the processor coupled to a computer readable memory, the memory comprising:
a ready list including a list of titles corresponding to video files that are downloaded to a memory within a set top box and suitable for display at the display device; and
a queue list including a second list of titles corresponding to video files that are targeted to be downloaded to the memory within the set top box.

25. The system of claim 24, wherein the memory further comprises:
an action list displayable at the display device.

26. The system of claim 25, wherein the action list includes a play key, a summary key, a move up key, a move down key, and a delete key.

27. The system of claim 24, further comprising a remote control, wherein the set top box is responsive to wireless signals generated by the remote control.

28. The system of claim 26, wherein the memory further comprises:
instructions for detecting the selection of a movie title from the ready list;
instructions for detecting the selection of the play key;
instructions for activating a parental control process; and
instructions for activating a purchase control process.

29. The system of claim 28, wherein the memory further comprises:
instructions for receiving a parental control password;
instructions for receiving a purchase control password; and
instructions for verifying the parental control password and the purchase control password.

30. The system of claim 29, wherein the computer program further comprises:
instructions for downloading a video file corresponding to the movie title; and
instructions for displaying a video file corresponding to the movie title.

31. The system of claim 30, wherein the computer program further comprises:
instructions for detecting when the video file has ended;
instructions for deleting the video file from memory; and
instructions for deleting the movie title corresponding to the video file from the ready list.

32. The system of claim 26, wherein the computer program further comprises:
instructions for detecting the selection of a movie title from the queue list;
instructions for detecting the selection of the play key; and
instructions for displaying a delete selection screen when the number of movie titles in the ready list is greater than a predetermined limit.

33. The system of claim 32, wherein the computer program further comprises:
instructions for downloading a video file corresponding to the movie title selected from the queue list;
instructions for moving the movie title from the queue list to the ready list after a predetermined time limit; and
instructions for indicating that the video file is ready for display.
